(19) United States
(12) Patent Application Publication
(10) Pub. No.: US 2012/0260920 A1
(43) Pub. Date: Oct. 18, 2012

(54) FACE MASK HAVING WELDED THERMOPLASTIC MASK BODY

(75) Inventors: Dong-Il Choi, Gyeonggi-Do (KR); Kyoung-Ho Lee, Hwaseong-Si (KR); Jin-Ho Lee, Seoul (KR); BongHyup Kang, Seoul (KR); Dong-Sun Noh, Bucheon-Si (KR)

(73) Assignee: 3M Innovative Properties Company

(21) Appl. No.: 13/087,629

(22) Filed: Apr. 15, 2011

(51) Int. Cl. A62B 23/02

(52) U.S. Cl. 128/206.12

(57) ABSTRACT

A respirator 10 that includes a mask body 12 and at least one filter cartridge 24. The mask body 12 has a central portion 14 and a peripheral portion 16. The filter cartridge 24 is attached to the rigid central portion 16. The peripheral portion 14 is made from a low stiffness first thermoplastic material, and the central portion 16 is made from a rigid second thermoplastic material. The first thermoplastic material is welded to the second thermoplastic material. A respirator of this structure can be made in a convenient manner, with a sound hermetic bond between the parts, while also being light in weight.

The present invention pertains to a respirator where the central portion of the mask body is welded to the peripheral portion.

### BACKGROUND

Many respirators that are manufactured and sold today use a thin rigid structural part for attaching filter elements and valves to the mask body. These rigid structural parts are commonly produced through injection molding and are often referred to as the “nosepiece”, “rigid insert”, or “central portion”. An elastomeric compliant material, which conforms to a person's face, is commonly disposed peripherally on or about the rigid structural insert. The compliant peripheral portion contributes to a snug fit over the wearer's nose and mouth. The use of a rigid central portion in conjunction with a compliant peripheral portion tends to make the mask lighter and more comfortable to wear, particularly when compared to previous masks that had used thick rubber throughout essentially the whole mask body to support the filter cartridges and valves. Examples of masks that use a rigid insert in conjunction with a compliant face-contacting member are shown, for example, in U.S. Pat. No. 6,016,804 to Gleason et al. and U.S. Pat. No. 5,592,937 to Freund, and, and U.S. Pat. No. 7,650,884 to Flannigan et al.

To manufacture respiratory masks that use rigid central portions in conjunction with compliant peripheral portions, the peripheral portion is commonly overmolded onto the rigid central portion—see, for example, U.S. Pat. No. 5,062,421 to Burns et al. Such a manufacturing effort requires careful control of the injection molding operation to create a hermetic seal between the parts and requires that the compliant portion be assembled contemporaneously with the joinder of the parts.

### SUMMARY OF THE INVENTION

The present invention provides a respirator that comprises a mask body and at least one filter cartridge. The mask body includes a central portion and a face-contacting portion. The filter cartridge is secured to the central portion. The central portion comprises a rigid first thermoplastic material, and the face-contacting portion comprises a compliant nonelastomeric second thermoplastic material. The first thermoplastic material is welded to the second thermoplastic material.

The present invention also provides a new method of making a respirator that has a rigid central portion and a compliant peripheral portion. The method comprises the steps of: (a) providing a rigid central portion that comprises a first thermoplastic material; (b) providing a compliant peripheral portion that comprises a second thermoplastic material; and (c) welding the rigid central portion to the compliant peripheral portion such that a hermetic seal is created between the rigid central portion and the compliant peripheral portion.

The present invention differs from known respiratory masks that have a rigid central portion joined to the peripheral compliant portion in that the parts are both thermoplastic (in whole or in part) and are secured together through a welding operation rather than an overmolding step. Using the method of the present invention, a hermetic seal can be achieved between the rigid central portion and the compliant peripheral portion. As indicated above, conventional manufacturing methods have relied on an overmolding operation to achieve the hermetic seal between the parts. Heretofore it was not known that a sturdy hermetic seal could be achieved between such parts in a welding step; nor was a method of making such a secure joint known. The article and method of the present invention are beneficial in that the two parts can be made separately, allowing them to be subsequently joined together at a time and place convenient to the manufacturer. The resulting product costs also can be reduced using the method of the present invention. The inventive article can achieve a very good bond between the thermoplastic parts and can provide a sufficient structural integrity for the compliant portion while using less materials. This in turn creates a product that is light in weight, particularly when compared to known overmolded respiratory mask bodies. Respiratory masks that weigh less tend to be more comfortable to wear, particularly over extended time periods. Lightweight respiratory masks may improve wearer safety in that they are less likely to be removed from the face in the workplace.

### Glossary

In this document, the terms set forth below will have the definitions that follow:

“compliant peripheral portion” means the portion of a mask body that engages the central portion and extends laterally therefrom and is compliantly fashioned for allowing the mask body to be properly disposed on a person's nose and mouth;

“exterior gas space” means the ambient atmospheric gas space that surrounds a mask body when worn on a person and that ultimately receives exhaled gas after it exits the interior gas space of the mask body;

“rigid central portion” means a rigid part that provides structural integrity to a facemask body to allow filtration elements (such as filter cartridges) and/or valves to be adequately secured thereto;

“face seal” means a part or parts that engage the face when the mask body is worn in its intended position on a person's face;

“fluid communication component” means an element that is structured to allow a fluid to pass from an interior gas space to an exterior gas space or vice versa;

“harness” means an element or combination of elements or parts, which elements or combination, allows a mask body to be supported at least over a wearer's nose and mouth;

“interior gas space” means the space that exists between a mask body and a person's face when the respirator is being worn;

“mask body” means a structure that can fit at least over the nose and mouth of a person and that can help define an interior gas space separated from an exterior gas space;

“non-integral” means the parts are made separately before being joined together;

“polymer” means a material that contains repeating chemical units, regularly or irregularly arranged;

“polymeric” and “plastic” each mean a material that mainly includes one or more polymers and that may contain other ingredients as well;

“thermoplastic” means a polymer or polymeric material that may be softened by heat and hardened by cooling in a reversible physical process; and

“weld” or “welding” means the act of joining parts together by melting or liquefying the parts (or portions thereof) to be joined.

### BRIEF DESCRIPTION OF DRAWINGS

FIG. 1 is a perspective view of a respiratory mask 10;

FIG. 2 is a perspective view of a mask body 12;

FIG. 3 is a rear view of the rigid central portion 16; and

FIG. 4 is an enlarged view of the weld 60 between the compliant peripheral portion 14 and the rigid central portion 16 and the of the mask body 12.

### DETAILED DESCRIPTION OF PREFERRED EMBODIMENTS

In the practice of the present invention, a rigid central portion is welded to a compliant peripheral portion to create a mask body that is light in weight and that has a hermetic seal between the two parts. The welding step allows the two parts to be made separately and to be secured together at a later point in time convenient to the manufacturer. When the mask body is made from a non-elastomeric material, the mask body can be made to contain less mass of mask body material. The resulting respiratory mask may therefore weigh less than a similar mask body made from overmolding operations where an elastomeric compliant portion is used. Further, the mask body can achieve sufficient structural integrity without need for reinforcing structural lines and members. Thus, a light weight product can be produced in a convenient manner with a sound hermetic bond between the parts.

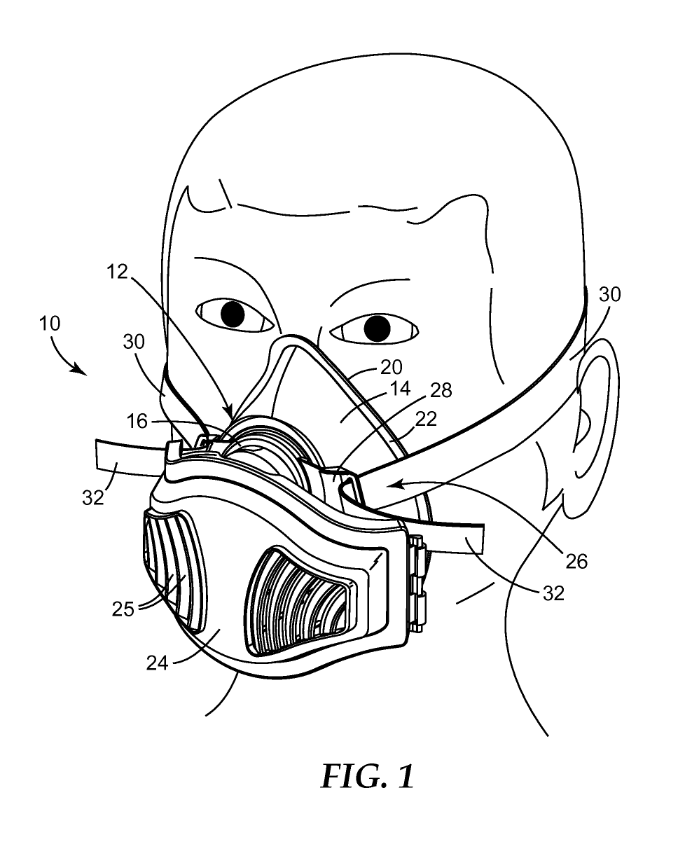

FIG. 1 shows a respiratory mask 10 that has a mask body 12 that has a compliant peripheral portion 14 secured to the rigid central portion 16. The compliant portion 14 enables the mask body 12 to be comfortably placed over a person's nose and mouth. The peripheral portion 14 may have an integral in-turned feathered cuff so that the mask can fit comfortably and snugly over the wearer's nose and against the wearer's cheeks. Alternatively, a separate face seal 20 can be joined to the peripheral portion 14 along its perimeter 22. The rigid central portion 16 is disposed centrally in the mask body 12 to provide structural integrity sufficient to support one or more filter cartridges 24. The filter cartridge(s) 24 may be located centrally, or they may be located on opposing sides of the mask body 12. The filter cartridge 24 has one or more fluid intake openings 25 to allow ambient air to be drawn in through the filter media in the cartridge 24. A harness 26 is attached to the mask body 12 to allow the mask body 12 to be supported over a wearer's face. The harness 26 may include a yolk 28 that is secured to the mask body 12 at the central portion 16. One or more adjustable straps 30 may be joined to the yolk 28 at a first and second strap ends 32 on opposing sides of the central portion 16. The remainder of the strap 30 may extend behind the wearer's neck when the respirator 10 is in use. Straps 30 may likewise be adjustable and may include mating buckle parts. A crown member may be employed in the harness 26 to enable the respirator 10 to be comfortably supported from the back of a person's head—see for example, U.S. Pat. No. 6,732,733 to Brostrom et al.

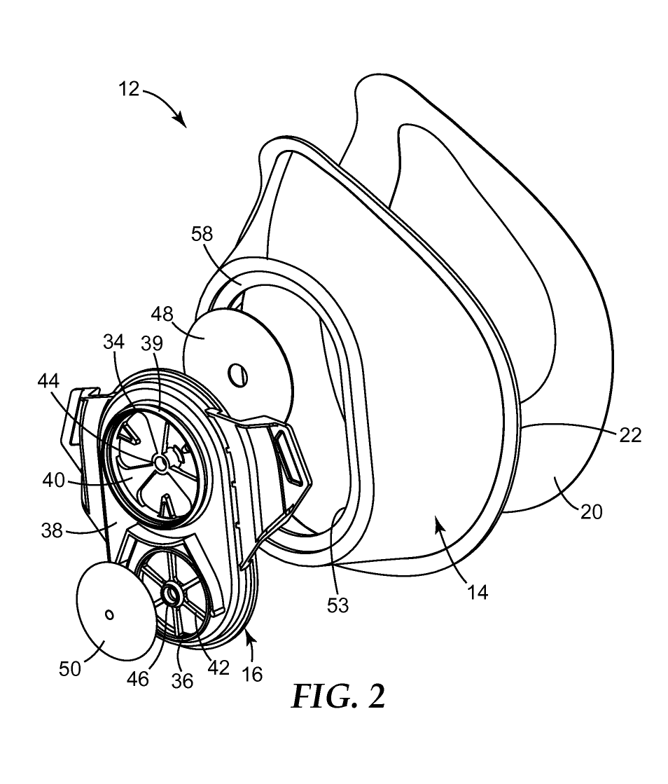

FIG. 2 shows the mask body 12 and its central and peripheral portions 14 and 16, respectively, and a face seal 20 that would extend radically inward from the perimeter 22 of the peripheral portion 14. The central portion 14 includes fluid communication components 34 and 36. The fluid communication components 34 and 36 allow inhaled and exhaled air, respectively, to be drawn into and removed from the mask body interior. The fluid communication components 34 and 36 have more detail and are generally subjected to greater tolerance requirements than the main supporting portion 38 of the central portion 14. Fluid communication component 34 is an inhalation valve that opens upon a wearer's inhalation and is forced closed upon an exhalation. Fluid communication component 36 is an exhalation valve that allows exhaled air to be displaced from the mask interior during each exhalation. The filter cartridge 24 can be secured to the central portion using a variety of mechanisms. The cartridge can be, for example, threaded onto the central portion 14, or it may be pressed onto the central portion using a snap-fit engagement apparatus. The filter cartridge 24 (FIG. 1) may be provided with an opening (on its rear side) whose inner aperture engages an outer aperture of the fluid communication component 34. When the filter cartridge 24 is pushed toward the mask body 12, the opening on the backside of the filter cartridge slightly expands and snaps onto the annular wall 39 that, in part, defines the fluid communication component 34 of the central portion 14—see U.S. Pat. Reissue 39,493 to Yuschak et al for a description of a snap-fit filter cartridge. Alternatively, the fluid communication component 34 could be provided with a bayonet structure that enables a filter cartridge or a supplied air source (not shown) to be attached to the facepiece central portion—see, for example, U.S. Patent Application US2005/0145249 to Solyntjes. A filter cartridge could be secured to the bayonet structure by placing its corresponding mating structure over bayonet structure and rotating the filter cartridge relative to the mask body 12. The filter cartridge may be removed from the mask body by rotating it in the opposite direction. A removable filter cartridge can be beneficial in that it allows the mask body to be reused when the filter cartridge has met the end of its service life. The filter cartridge also can be permanently attached to ensure that the cartridge never comes loose—see U.S. Pat. No. 5,062,421 to Burns and Reischel. Air that passes through the filter cartridge enters the interior gas space during an inhalation but is prohibited from passing from the interior gas space into the filter cartridge via the valve orifice during an exhalation. Exhaled air that is purged from the interior gas space through the exhalation valve 36 enters the exterior gas space, thus making the mask more comfortable to wear. Valves 34 and 36 include, respectively, a series of spokes 40, 42 that support a central hub 44, 46 to which a valve flap or diaphragm 48, 50 may be attached to create a button-style valve. Alternatively, flapper or cantilevered valves could be used, particularly as exhalation valves, for purging exhaled air from the interior gas space. Examples of exhalation valves that may be suitable for use on a mask body of the invention include the valves that are disclosed in U.S. Pat. Reissue 37,974 to Bowers, and U.S. Pat. Nos. 7,493,900 and 7,428,903 to Japuntich et al., and 7,188,622 to Martin et al., and in U.S. Pat. No. 7,849,856 to Mittelstadt et al. Although the central portion 16 is shown in the drawings as being a single, albeit non-integral part, the present invention contemplates a facepiece insert that is comprised of multiple separate parts—see, for example, U.S. Pat. No. 5,592,937 to Freund. The compliant face contacting member 14 also could conceivably comprise one or more separate parts as well.

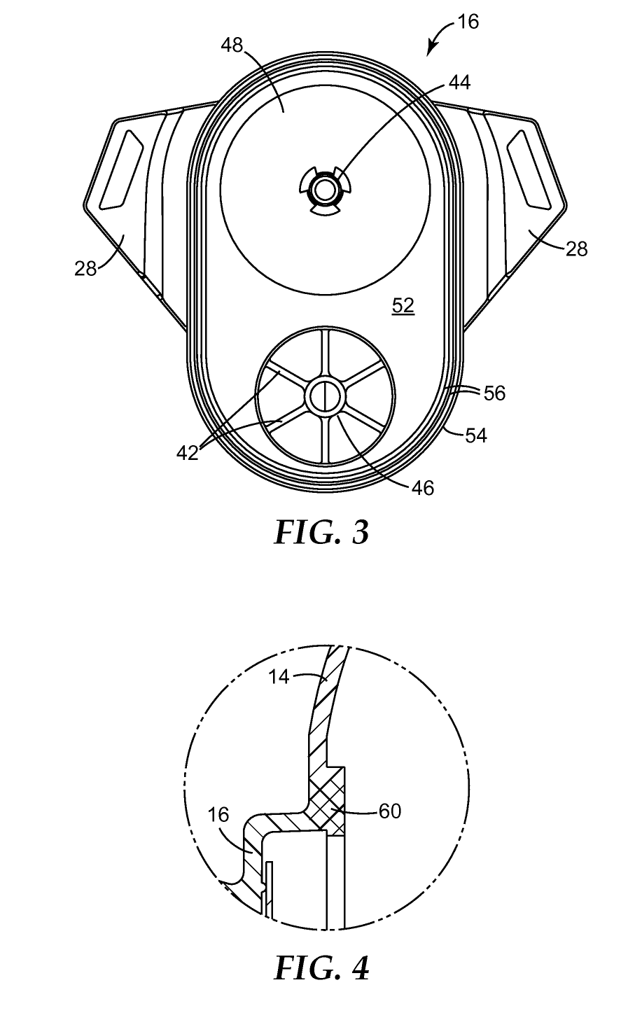

FIG. 3 shows the rear face 52 of the central portion 16. In assembling the mask body, the peripheral portion 14 (FIGS. 1 and 2) is welded to central portion 16 along the perimeter 54. To facilitate the welding operation, the rear face 52 of the central portion 16 may be provided with one or more energy directors 56 to encourage welding energy transmission—see, for example, U.S. Pat. No. 6,729,332 to Castiglione. Alternatively, the peripheral portion may be fashioned with energy directors. The energy directors 56 may extend continuously around the circumference 56 of the central portion 16 (or the peripheral portion or both). The energy directors 56 typically are about 0.3 to 1.5 mm high and are about 0.2 to 1.0 mm wide. The energy directors 56 comprise a thermoplastic material and may be fashioned to mate with a smooth or complementary thermoplastic surface on the peripheral portion 14. Such a thermoplastic surface may comprise the annular surface 58 (FIG. 2) located radially inward on the peripheral portion 14. The annular surface 58 may be an oval, elliptical, circular, etc. The mating surfaces on the central portion and the peripheral portion may be made of first and second thermoplastic materials where the first and second materials may be the same or different. The marrying of the two parts may be achieved by ultrasonically welding, hot plate welding, radio frequency welding, laser welding, heated tool welding, vibration welding, or any other technique suitable to deliver sufficient heat and/or pressure to join the first and second thermoplastic materials together. Material compatibility requirements between pieces, regardless of the welding method, would be generally similar.

FIG. 4 shows a cross section of the welding joint 60 between the peripheral portion 14 and the central portion 16. As illustrated, the portions 14 and 16 become welded at the joint 60 such there is not a definitive line between the first and second thermoplastic materials. The heat and/or pressure that is applied to secure the weld is sufficient to cause the first and second thermoplastic materials to melt or fuse together to cause a hermetic bond between the two portions. The bond not only is hermetic, but it also has adequate strength to enable the two parts to remain joined together throughout the useful life of the respirator. The principle of ultrasonic assembly involves the use of high-frequency mechanical vibrations transmitted through thermoplastic parts to generate a frictional heat build-up at an interface. Ultrasonic vibrational energy at the interface of the plastic parts being joined causes the plastic material to soften and flow. When the materials are pressed together, liquefied, and re-solidified, the bond is created. Polymer structure and other factors affect the weldability of various polymers. Polymers useful in the invention are thermoplastic polymers that have sufficient compatibility to enable the materials to be joined together in a welding operation. Polymeric alloys and blends of polymers can be used. Major factors that influence material compatibility for welding include polymer structure, melt temperature, melt index (flow), modulus of elasticity (stiffness), and chemical makeup.

Amorphous and semi-crystalline polymers such as polyamides, polyesters, polycarbonates, polystyrenes or modified styrenic copolymers, and polyolefins may be usefully employed in the present invention. Amorphous polymers, such as acrylonitrile butadiene styrene (ABS), polystyrene (PS), styrene acrylonitrile (SAN), and polyvinyl chloride (PVC) are recognized as having beneficial weldability properties. Semi-crystalline polymers such as polypropylene (PP), polyethylene (PE), and polyethylene terephthalate (PET) are also recognized as having beneficial weldability properties. Welding often is accomplished between pieces formed from like materials, however, some amorphous polymers such as poly(methyl methacrylate) (PMMA) and polycarbonate (PC) can be successfully welded. Melt index, or flow rate, is the rate at which a material flows when it becomes molten. Different grades of the same material may have different flow rates (e.g., an injection molded nylon and an extruded nylon). Such differences may result in the melting of one component of the assembly and not the other during welding—possibly resulting in a homogeneous bond. To achieve compatibility, in terms of melt index (flow), the melt flow of the pieces to be welded generally may be within 2 to 4 units as defined by ASTM D1238. In addition, to weld dissimilar plastics, the plastics to be welded typically must possess a like molecular structure (that is be chemically compatible) with some component of the material, usually a blend. Generally compatible thermoplastics having like radicals present, and the sufficient percentage of the like chemical radical, will determine the molecular compatibility. When welding chemically compatible, but dissimilar resins, the melt temperature of the resins of each part should not generally be separated by greater than about 22 degrees centigrade.

The peripheral portion can be made by vacuum forming a thermoplastic polymeric sheet. The resulting formed sheet must be sufficiently rigid so as to retain the general face-contacting shape while being compliant enough to yield to the features of the face to assure wearer comfort and afford the best face seal. The peripheral portion additionally must be resistant to collapse that could result from the tension of the head straps and be rigid enough to support the bearing weight of cartridges and filter holders. U.S. Patent application US2005/0211251 to Henderson et al. describes how a non-elastomeric mask body can be thermoformed. The inner perimeter of the peripheral portion is welded to the central portion such that a leak free weld is achieved when tested according to the Hermetic Seal Test set forth below. The weld strength between the parts is at least 100 Newtons, more typically at least 150 Newtons, and still more typically at least 200 Newtons. The face seal can be made from sheets of compliant thermoplastic elastomer material nominally less than 0.5 millimeters thick. Sheets of material are typically formed using a cutting die in the shape of the outline of the perimeter of the peripheral portion of the mask. A cutting die also is generally used to cut out a central breathing opening in the face seal where the opening is fashioned to be centered in front of the nose and mouth of a wearer. Any number of cutting methods, which would accomplish the desired results, could be used to form the face seal such as laser or water jet cutting. Once formed, the thermoplastic face seal is attached to the outer perimeter of peripheral portion of the mask by heat bonding. The bonding can be accomplished by various hot-tool fusing methods. When attached to the mask, the face seal provides a highly compliant or elastomeric band of material that extends radially inward towards the mask center. The highly compliant band of material functions in concert with the peripheral portion to afford a tight face fit to a wearer.

### Examples

### Hermetic Seal Test

The hermetic seal between the central portion and peripheral portion of a respirator mask body was evaluated using a liquid colorimetric indicator and a reactive challenge gas. The indicator used was a 1% phenolphthalein solution in isopropyl alcohol, and the challenge gas was 300 parts per million (ppm) of ammonia in air. In the event of contact between the indicator and challenge gas, the indicator would turn red, as a result of the solution turning basic because of ammonia contact.

To conduct an evaluation, a test mask was mounted on a mannequin head. A through-hole was provided in the test mask so that the challenge gas could be delivered to the respirator interior gas space. The mask body was then sealed to the mannequin so that no gas leakage could occur at the mask interface. Any mask body openings, such as the exhalation or inhalation valve ports, also were sealed. The mask thus was ready for the challenge procedure, which involved wetting a white cotton cloth with indicator solution and covering the mask. When the mask body was completely enveloped in the wetted cloth, the challenge gas was delivered to the interior gas space. The challenge gas was gradually delivered at a rate of approximately 30 liters per minute until the internal pressure reached 2 kilopascals (kPa). After one minute, the cloth with indicator was observed for a color change. A change from white to red on any surface of the cloth indicated a leak was present.

### Weld Strength Test

Mechanical strength of the weld between the central portion and peripheral portion was measured as the force, under tension, sufficient to cause the onset of separation between the parts when placed under a normally directed load. When deformed beyond the separation onset, it would be expected that leakage would occur between the parts. Tests were performed on an assembly of a mask body and mounting fixture, with the nose and peripheral portions of the mask secured to a fixture so that the mask body could be put in tension along a center line normal to the mask. The assembly was mounted in a tensile tester, MTS Landmark, MTS Systems Corporation, 14000 Technology Drive Eden Prairie, Minn. 55344 and was subjected to a tensile load delivered at a crosshead speed of 50 millimeters per minute. The maximum tensile load was recorded.

### Respirator Assembly

A respirator was made which resembled the device shown in FIG. 1. The respirator was formed from three primary elements: a peripheral portion, a central portion, and face seal.

The peripheral portion was made from an extruded sheet of low-stiffness thermoplastic polyolefin, Softel, grade CA 02 A, Basell Polyolefins Korea Ltd, Seoul, Republic of Korea. A 1.5 millimeter (mm) sheet was extruded at approximately 200° C. and was cooled. The sheet was then cut to a width of 140 mm and a length of 155 mm. The cut sheet was then used in a vacuum forming process to create the peripheral portion.

The peripheral portion was formed in a vacuum forming process that included clamping the cut sheet into a forming frame, heating the sheet to a temperature of approximately 130° C., and then raising a mold of the peripheral portion onto the sheet from below. Trapped air between the sheet and mold was evacuated with the assistance of a vacuum pump that delivered a vacuum of 133 Pascals (Pa). The sheet was closely drawn to the mold and was then allowed to cool for 20 to 30 seconds. Once cooled, a reverse air supply was activated to release the peripheral portion part from the mold. The peripheral portion part was then trimmed to form the mask perimeter, and an open section was cut from the center front of the peripheral portion to provide an opening for receiving the central portion. The shape of the finished peripheral portion generally resembled the peripheral portion shown in the drawings. The width of the peripheral portion at its widest distance was 110 mm, the height of the peripheral portion from top to bottom was 140 mm, and the depth of the peripheral portion, from the center of a plane defining the front opening 53 to a plane parallel to the rear opening that contacted the mask perimeter 22 on the back of the peripheral portion, was 40 mm. After preparation of the peripheral portion, the face seal was affixed to the peripheral portion perimeter.

The face seal was die-cut from a sheet of a styrene thermoplastic elastomer. The 0.3 mm thick sheet was extrusion formed from SEBS, K9120, Keumho Petrochem, Seoul, Republic of Korea and was cut into the correct shape using a rule die. The shape of the face seal followed the shape of the outer perimeter of the peripheral portion, with a central opening generally following the outline of the perimeter but 20 mm from the edge of the peripheral portion. The precut face seal was attached to the outer perimeter of the peripheral portion by a heat bonding process. Bonding temperature was about 130° C., with a bonding pressure of about 70 kPa for a dwell time of 1.5 seconds. After attachment of the face seal to the peripheral portion, the central portion was affixed to the peripheral portion.

The central portion was formed in an injection molding process using polypropylene with a magnesium silicate additive, Fiberfill PP-68/TC/20 Polypropylene Copolymer from Ado Compounders under the Matrixx Group, ON Canada. The central portion had a nominal wall thickness of 1.5 mm and was configured to be located at the opening of the peripheral portion and was aligned on the opening perimeter shelf 58, as illustrated in FIG. 2. Width of the central portion at the widest part was about 4 centimeters Length of the central portion, from top to bottom, was 82 mm, and the thickness of the central portion was 18 mm. Once located on the peripheral portion, the central portion was ultrasonically welded to the peripheral portion at the energy directors 56 (FIG. 3). Ultrasonic welding was accomplished using a near-field horn and anvil arrangement with an ultrasonic welding machine Branson 2000X, Branson Ultrasonic Corporation, P.O. Box 1961, Danbury, Conn. 06813-1961. The horn and anvil were configured to seal the perimeter contact area of the central portion to the opening perimeter shelf 58 of the peripheral portion in one step. The total weld area was about 965 square mm. The compression pressure was about 551 kPa, the horn welding energy was 500˜700 hertz, the trigger force was 15 kPa, the down speed was 15 mm/second, and the dwell time 0.5 was seconds. Temperature of the parts just before welding was 22° C.

The peripheral portion material comprised an olefin based tri-block copolymer that had about 20% of polypropylene in the olefinic composition. The central portion was comprised of polypropylene and 20 weight percent talc to increase mechanical stability. The peripheral portion and central portion material had melting temperatures of about 145° C. and 165° C., respectively.

After the assembled mask was allowed to cool from the welding process, it was tested in accordance with the Air Tightness and Weld Strength test methods. Under these tests, it was confirmed that the welded seal between the peripheral portion and central portion was both hermetic and mechanically stable. The leak test, conducted at 2 kPa, showed no leakage while the weld strength was over 230 Newtons. A robust weld was therefore achieved.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

What is claimed is:

1. A respirator that comprises:
(a) a mask body that comprises:
(i) a central portion that comprises a rigid first thermoplastic material;
(ii) a face contacting member that comprises a compliant non-elastomeric second thermoplastic material, wherein the first thermoplastic material is welded to the second thermoplastic material to create a hermetic seal between the central portion and the peripheral portion; and
(b) at least one filter cartridge that is secured to the rigid central portion.

2. The respirator of claim 1, wherein the first and second thermoplastic materials are ultrasonically welded, hot plate welded, or radio frequency welded.

3. The respirator of claim 2, wherein the first and second thermoplastic materials are ultrasonically welded together.

4. The respirator of claim 1, wherein the peripheral portion comprises a first opening and a thermoplastic perimeter disposed about the first opening, the central portion also comprising a thermoplastic perimeter, the thermoplastic perimeter of the central portion being welded to the thermoplastic perimeter of the peripheral portion.

5. The respirator of claim 4, wherein the central portion comprises visible thermoplastic energy directors at the perimeter of the central portion before being welded to the peripheral portion.

6. The respirator of claim 5, wherein the peripheral portion comprises a thermoplastic surface that becomes welded to the perimeter of the central portion.

7. The respirator of claim 4, wherein the mask body further comprises an elastomeric face seal that is secured to the peripheral portion at a second perimeter.

8. The respirator of claim 1, wherein the peripheral portion is thermoformed into its desired shape.

9. The respirator of claim 1, wherein the first and second thermoplastic materials that are welded together comprise an amorphous polymer.

10. A method of making a respirator, which method comprises the steps of:
(a) providing a rigid central portion that comprises a first thermoplastic material;
(b) providing a compliant peripheral portion that comprises a second thermoplastic material; and
(c) welding the rigid central portion to the compliant peripheral portion such that a hermetic seal is created between the rigid central portion and the compliant peripheral portion.

11. The method of claim 10, wherein the first and second thermoplastic materials are ultrasonically welded together.

12. The method of claim 11, wherein the rigid central portion comprises thermoplastic energy directions that extend annularly around a perimeter of the central portion.

13. The method of claim 12, wherein the peripheral portion comprises an annular thermoplastic surface which becomes ultrasonically welded to the central portion at its perimeter.

14. The method of claim 10, wherein the first and second thermoplastic materials comprise an amorphous polymeric material.

15. The method of claim 14, wherein the amorphous polymeric material includes polypropylene.

16. The method of claim 10, further comprising securing a face seal to an outer perimeter of the peripheral portion.

17. The method of claim 16, wherein the peripheral portion is non-elastomeric and the face seal is elastomeric.
